(19) United States
(12) Patent Application Publication
(10) Pub. No.: US 2026/0222453 A1
(43) Pub. Date: Jul. 30, 2026

(54) SECURE IP MULTIMEDIA SUBSYSTEM (IMS) CALLS

(71) Applicant: Motorola Mobility LLC, Chicago, IL (US)

(72) Inventors: Ranjeet Gupta, Aurora, IL (US); Daniel C. Chisu, Franklin Park, IL (US)

(73) Assignee: Motorola Mobility LLC, Chicago, IL (US)

(21) Appl. No.: 19/037,778

(22) Filed: Jan. 27, 2025

(51) Int. Cl. H04L 65/1016; H04W 12/08; H04W 36/30

(52) U.S. Cl. CPC H04L 65/1016; H04W 12/08; H04W 36/30

(57) ABSTRACT

Secure IP Multimedia Subsystem (IMS) calls are discussed herein. A determination is made that an IMS call is about to be launched at a computing device. One or more wireless networks accessible to the computing device are identified. A first wireless network of the one or more wireless networks having a security level that satisfies security criteria for the IMS call is automatically selected, and the IMS call is performed via the first wireless network.

### BACKGROUND

As technology has advanced our uses for computing devices have expanded. One such use is wireless communication. Some computing devices, such as cell phones and smart watches, are mobile devices and can communicate with other devices wirelessly. However, such wireless communication is not without its problems. One such problem is security. Malicious users or devices can sometimes intercept or eavesdrop on wireless communications, which can result in private information being revealed so such malicious users or devices. Various security technologies, such as encryption, can be used to protect against such interception or eavesdropping on wireless communications.

### BRIEF DESCRIPTION OF THE DRAWINGS

Embodiments of secure IP Multimedia Subsystem (IMS) calls are described with reference to the following drawings. The same numbers are used throughout the drawings to reference like features and components:

FIG. 1 illustrates an example system including a computing device implementing the techniques discussed herein;

FIG. 2 illustrates an example system implementing the techniques discussed herein;

FIG. 3 illustrates an example of implementing the techniques discussed herein.

FIGS. 4-7 illustrate example processes for implementing the techniques discussed herein in accordance with one or more embodiments;

FIG. 8 illustrates various components of an example electronic device that can implement embodiments of the techniques discussed herein.

### DETAILED DESCRIPTION

Secure IMS calls are discussed herein. Generally, a computing device, such as a wireless phone or smartwatch, is able to connect to different wireless networks at different times and different geographical locations, such as different wireless local area networks (WLANs) and different wireless wide area networks (WWANs). Different wireless networks can have different levels of security. For example, some wireless networks encrypt communications between devices and other wireless networks do not encrypt communications between devices, different wireless networks can have different strengths or levels of encryption (e.g., use different encryption key lengths), and so forth.

Two or more different computing devices can communicate with one another via an IMS call using any of a variety of different wireless networks. An IMS call can by any of a variety of different types of calls, such as a voice call (e.g., voice over LTE (VoLTE), voice over new radio (VONR), or voice over Wi-Fi (VoWiFi)), a video telephony (VT) call, a real-time text (RTT) call, or a traditional rich communication services (RCS) message, or a combination thereof. When communication with another computing device is about to begin (e.g., an IMS call is launched), the computing device automatically selects a wireless network. For example, in situations where there are multiple wireless networks accessible to the computing device, the computing device can automatically select one of the multiple wireless networks having a highest security level or having a security level that satisfies security criteria for the IMS call. If the computing device is not already connected to the selected wireless network, the computing device automatically connects to the selected wireless network, performs the IMS call, and then reconnects with the original wireless network (e.g., the wireless network the computing device was connected to prior to performing the IMS call) when the IMS call has been completed.

In contrast to traditional techniques that determine which wireless network to connect to based only on the signal strengths of the various wireless networks, the techniques discussed herein determine which wireless network to connect to based at least in part on the IMS call to be performed with another computing device. This allows the IMS call to be secure, then allows the computing device to reconnect to a different wireless network (e.g., the wireless network having the strongest signal) when the IMS call is completed.

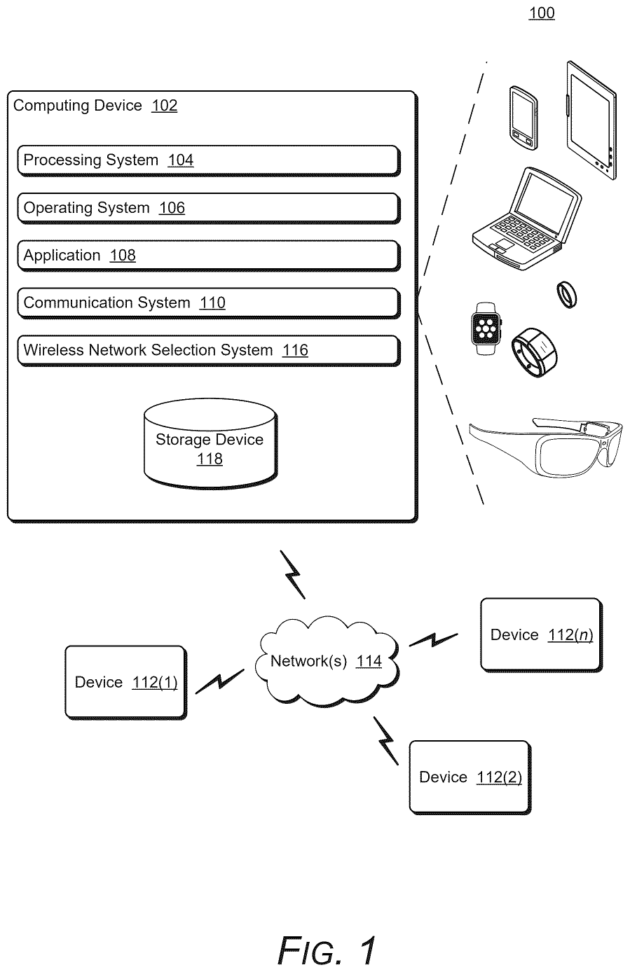

FIG. 1 illustrates an example system 100 including a computing device 102 implementing the techniques discussed herein. The computing device 102 can be, or include, many different types of computing or electronic devices. For example, the computing device 102 can be a smartphone or other wireless phone, a notebook computer (e.g., netbook or ultrabook), a laptop computer, a camera (e.g., compact or single-lens reflex), a wearable device (e.g., a smartwatch, a ring or other jewelry, augmented reality headsets or glasses, virtual reality headsets or glasses), a tablet or phablet computer, a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, a fitness tracker, a smart TV, an automotive computer, and so forth.

The computing device 102 includes a processing system 104 that includes one or more processors, each of which can include one or more cores. The processing system 104 is coupled with, and may implement functionalities of, any other components or modules of the computing device 102 that are described herein. In one or more embodiments, the processing system 104 includes a single processor having a single core. Additionally, or alternatively, the processing system 104 includes a single processor having multiple cores or multiple processors (each having one or more cores).

The computing device 102 also includes an operating system 106. The operating system 106 manages hardware, software, and firmware resources in the computing device 102. The operating system 106 manages one or more applications 108 running on the computing device 102 and operates as an interface between applications 108 and hardware components of the computing device 102.

The computing device 102 also includes a communication system 110. The communication system 110 manages communication, such as IMS calls, with various other devices 112(1), . . . , 112(n) via one or more networks 114. The devices 112(1), . . . , 112(n) can be, for example, other computing devices analogous to the computing device 102. The one or more networks 114 can include wireless networks and/or wired networks. The one or more networks 114 can include wireless networks such as at least one WLAN and/or at least one WWAN. The computing device 102 can thus communicate with other devices wirelessly and accordingly is also referred to as a wireless device.

Different networks 114 can have different security levels that indicate a type of security (e.g., a strength or type of security, or how well the network protects data from being intercepted or understood by eavesdroppers or malicious entities), as discussed in more detail below. For example, a WWAN can support wireless communications across various radio access technologies (RATs) including third generation (3G) radio access technology, fourth generation (4G) radio access technology, fifth generation (5G) radio access technology, 5G advanced (5G A), or other suitable radio access technologies beyond 5G (e.g., sixth generation (6G)). Each of these different radio access technologies can have different levels of security. By way of another example, a WLAN can support different levels of security, such as no security (e.g., an open network), wired equivalent privacy (WEP), Wi-Fi protected access (WPA), Wi-Fi protected access 2 (WPA 2), Wi-Fi protected access 3 (WPA3), Wi-Fi protected access 4(WPA 4 ), WLAN enterprise, and so forth.

The computing device 102 also includes a wireless network selection system 116 that automatically selects a wireless network for an IMS call. The wireless network selection system 116 can be implemented in a variety of different manners. For example, the wireless network selection system 116 can be implemented as multiple instructions stored on computer-readable storage media and that can be executed by the processing system 104. Additionally, or alternatively, the wireless network selection system 116 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The computing device 102 can connect to one or more wireless networks to communicate with one or more of the devices 112(1), . . . , 112(n). Connecting to a wireless network refers to establishing a communication link between the computing device 102 and a network entity (e.g., a base station for a WWAN wireless network, a wireless access point or router for a WLAN wireless network). Connecting to the wireless network can also include registering with the wireless network. This communication link is established without the use of physical cables or wires, and is referred to as wireless. Disconnecting from a wireless network refers to ending the communication link between the computing device 102 and the network entity.

Different networks 114 can be implemented in different manners and can use different technology to support communication between the computing device 102 and one or more of the devices 112(1), . . . , 112(n). One type of network supports IMS calls between the computing device 102 and one or more of the devices 112(1), . . . , 112(n). IMS refers to a framework for delivering communication services, including voice, video, and/or text. An IMS call is made over an IP (Internet Protocol) network and IMS allows communication across different wireless networks. Examples of such IMS calls include voice calls, audio/video calls, text messages or multimedia messages (e.g., RCS messages), and the like. These IMS calls may also be referred to as voice over IP, voice over Wi-Fi, video telephone, and the like.

The computing device 102 also includes a storage device 118. The storage device 118 can be implemented using any of a variety of storage technologies, such as magnetic disk, optical disc, Flash or other solid state memory, and so forth. The storage device 118 can store various program instructions and data for any one or more of the operating system 106, application 108, and the wireless network selection system 116.

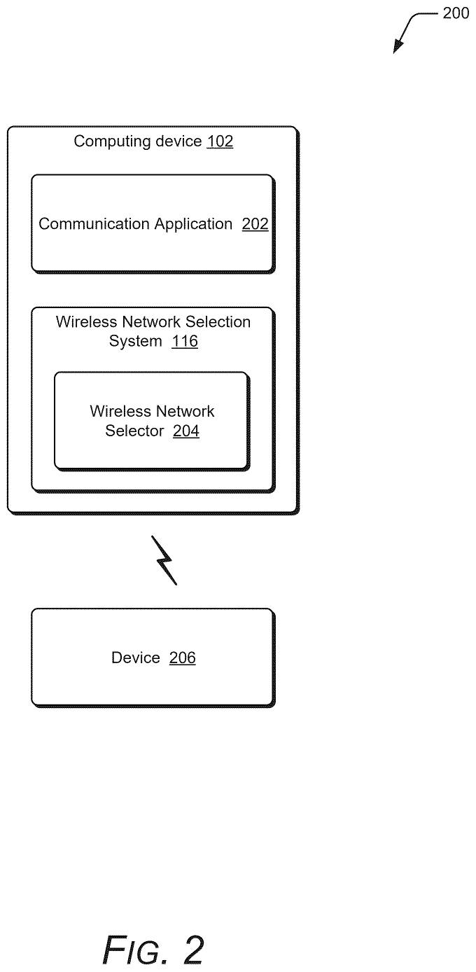

FIG. 2 illustrates an example system 200 implementing the techniques discussed herein. The system 200 includes the computing device 102 with a communication application 202 that supports IMS calls. The communication application 202 can be implemented in a variety of different manners. For example, the communication application 202 can be implemented as multiple instructions stored on computer-readable storage media and that can be executed by the processing system 104 of FIG. 1. Additionally, or alternatively, the wireless network selection system 116 can be implemented at least in part in hardware (e.g., as an ASIC, a FPGA, an ASSP, a SoC, a CPLD, and so forth).

The computing device 102 also includes the wireless network selection system 116 of FIG. 1, which includes a wireless network selector 204. The computing device 102 can communicate with a device 206 via one or more wireless networks as discussed above. The device 206 can be a device 112 of FIG. 1. The wireless network selector 204 selects a wireless network for a communication (e.g., an IMS call) with the device 206 as discussed in more detail below.

The wireless network selector 204 determines to automatically select a wireless network when an IMS call is about to be launched at or on the computing device 102. Determining that an IMS call is about to be launched refers to determining or having an expectation that an IMS call will be requested, transmitted, or received in the near future (e.g., within a threshold amount of time). The wireless network selector 204 can determine that an IMS call is about to be launched at or on the computing device 102 in any one or more of a variety of different manners. In one or more implementations, the wireless network selector 204 determines that an IMS call is about to be launched at or on the computing device 102 in response to receiving, via a wireless network that the computing device 102 is currently connected to, an indication that there is an incoming call (e.g., an incoming IMS call) to be communicated to the computing device 102. Additionally, or alternatively, the wireless network selector 204 determines that an IMS call is about to be launched at or on the computing device 102 in response to a user input (e.g., user selection of a “call” or “compose message” button). Additionally, or alternatively, the wireless network selector 204 determines that an IMS call is about to be launched at or on the computing device 102 in response to opening, launching, or running a particular application (e.g., the communication application 202).

Additionally, or alternatively, the wireless network selector 204 determines that an IMS call is about to be launched at or on the computing device 102 in response to a particular application (e.g., the communication application 202) becoming a foreground application at the computing device 102. An application can be run on the computing device 102 as a foreground application or a background application. A foreground application refers to an application that is visible to and/or providing video and/or audio output to the user (e.g., an application that has the user's attention). A foreground application is typically the application that is displayed by the computing device 102. A background application refers to an application that is not visible to and/or providing audio output to the user (e.g., an application that the user is not focusing on, and that the user is not actively using).

The wireless network selector 204 detects or determines the security level of wireless networks that are available to the computing device 102. A wireless network is available to the computing device 102 when the computing device 102 can receive the wireless network signals (e.g., from a base station, a repeater, a wireless access point, a router, and so forth). In an example, a wireless network is available to the computing device 102 when the wireless network signals received from the wireless network have at least a threshold signal strength (e.g., a received signal strength indicator (RSSI) that satisfies a threshold value). Available wireless networks can be detected or determined, for example, by performing a WWAN network scan to detect or determine available RATs, by performing a WLAN network scan to detect or determine available access points, or a combination thereof.

Different wireless networks can have different security levels. Generally, higher security levels provide more protection or security against malicious users or devices being able to intercept data or information sent by the computing device 102 or received by the computing device 102. These different security levels can be a result of different strengths or levels of encryption used (e.g., using different encryption key lengths), a level of international mobile subscriber identity (IMSI) and password encryption strength (e.g., a length of encryption key(s) used), using different encryption algorithms, implementing encryption at different layers of the wireless communication protocol stack, encrypting different types of identifiers or control information, performing different types of authentication, and so forth.

For WWAN wireless networks, newer generations can have better or higher security levels than older generations. For example, a 5G wireless network has a higher security level than a 4G wireless network.

For WLAN wireless networks, newer generations can have better or higher security levels than older generations. For example, a WPA4 wireless network can have a higher security level than a WPA3 wireless network, a WPA3 wireless network can have a higher security level than a WPA2 wireless network, and so forth.

Some wireless networks can be open wireless networks, which allow any device within range to connect to the wireless network without providing a password. Other wireless networks can be secure networks that require a password to connect to the network. Secure wireless networks can have a higher security level than open wireless networks. Open wireless networks that use encryption (e.g., opportunistic wireless encryption (OWE) as supported by WPA3) can have a higher security level than open wireless networks that do not use encryption. Open wireless networks that use encryption (e.g., OWE) can have a higher security level than some secure wireless networks (e.g., a higher security level than a WEP secure network but a lower security level than a WPA3 secure network).

In one or more implementations, a WWAN network has a higher security level than a WLAN network. Additionally, or alternatively, a WWAN network may or may not have a higher security level than a WLAN network. For example, a WPA4 WLAN wireless network can have a higher security level than a 3G WWAN wireless network, but a lower security level than a 5G WWAN wireless network.

In one or more implementations, wireless networks can be grouped into three groups. A first group has a lowest security level, and may include WEP wireless networks, WPA wireless networks, open wireless networks that do not include encryption, and 2G networks. A second group has a security level higher than the first group, and may include WPA2 wireless networks, WPA3 wireless networks, 3G wireless networks, and 4G wireless networks. A third group has a highest security level, higher than both the first group and the second group, and may include WPA4 wireless networks, 5G wireless networks, newer generation wireless networks than 5G (e.g., 5G A wireless networks, 6G wireless networks), and WLAN enterprise wireless networks.

In one or more implementations, the security levels for wireless networks, and/or which wireless networks have a higher security level than which other wireless networks, are configured in the computing device in various manners, such as pre-configured in the wireless network selection system 116 during manufacture of the computing device 102, received as user input at the computing device 102, provided to the computing device 102 from another device (e.g., a base station in a WWAN network), and so forth.

In one or more implementations, the wireless network selector 204 selects a wireless network having a highest security level for an IMS call with the device 206. Additionally, or alternatively, the wireless network selector 204 selects the wireless network in other manners. For example, the wireless network selector 204 can select the wireless network having the highest security level and the highest signal strength. By way of another example, the wireless network selector 204 can select the wireless network having the highest security level and having the highest data transfer speed or rate.

Additionally, or alternatively, different types of IMS calls (e.g., voice calls VT calls, RTT calls, RCS message(s)) can have different security criteria. The security criteria for a type of IMS call is an indication of how secure the wireless network is expected or desired to be in order to perform the IMS call over the wireless network. For example, the security criteria can be a particular security level the wireless network is to have in order for the IMS call of that type to be performed over the wireless network. For example, a voice call may have security criteria indicating a higher level of security is to be used than an RCS message.

Security criteria for a type of IMS call can be identified in any of a variety of different manners. In one or more implementations, the security criteria for a type of IMS call is specified by an application (e.g., the communication application 202) performing the IMS call or in metadata associated with the application (e.g., the communication application 202) performing the IMS call.

In one or more implementations, the wireless network selector 204 selects a wireless network that satisfies the security criteria for the type of IMS call. Additionally, or alternatively, the wireless network selector 204 can select the wireless network in other manners. For example, the wireless network selector 204 can select the wireless network that both satisfies the security criteria for the type of IMS call and has the highest signal strength. By way of another example, the wireless network selector 204 can select the wireless network that both satisfies the security criteria for the type of IMS call and has the highest data transfer speed.

If the computing device 102 is connected to a wireless network (also referred to as an original wireless network) other than the wireless network selected by the wireless network selector 204, the computing device 102 (e.g., the communication system 110 of FIG. 1) connects to the wireless network selected by the wireless network selector 204. This may include switching from one WWAN to another WWAN, switching from one WLAN to another WLAN, or switching between a WWAN and a WLAN. The computing device 102 may also disconnect from the original wireless network. An IMS call between the communication application 202 and the device 206 is performed over the wireless network selected by the wireless network selector 204. After the IMS call is completed (e.g., the communication application 202 is closed or is no longer the foreground application), the computing device 102 (e.g., the communication system 110) disconnects from wireless network selected by the wireless network selector 204 and connects to the original wireless network.

In situations where the computing device 102 is already connected to the wireless network selected by the wireless network selector 204, no change (e.g., connection to or disconnection from) in the wireless network that the computing device 102 is connected to need be made.

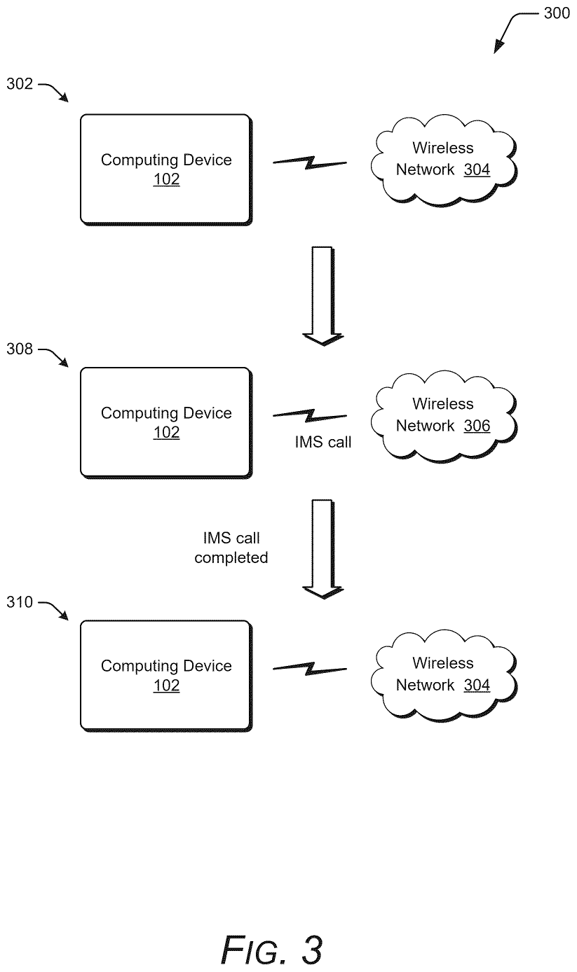

FIG. 3 illustrates an example 300 of implementing the techniques discussed herein. In the example 300, at 302 the computing device 102 is connected to a wireless network 304 and can communicate with other devices over the wireless network 304. An IMS call is about to be launched and the computing device 102 selects and connects to a different wireless network, wireless network 306 (e.g., having the highest security level or a security level that satisfies the security criteria for the IMS call).

At 308, the IMS call is performed over the wireless network 306. After the IMS call is completed (e.g., the user hangs up the call, the communication application 202 is closed or becomes a background application), the computing device 102 reconnects to the wireless network 304. At 310, the computing device 102 is connected to the wireless network 304 and can communicate with other devices over the wireless network 304.

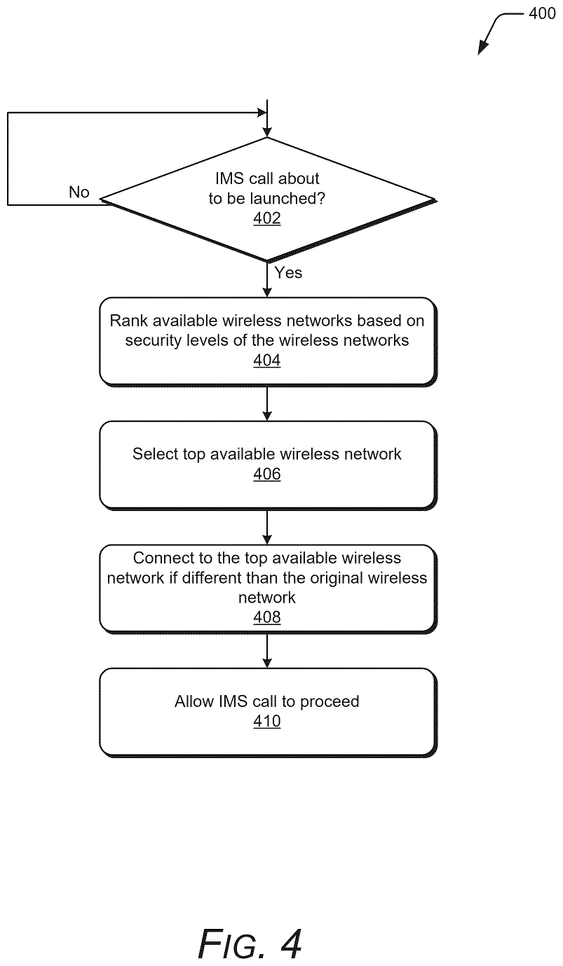

FIG. 4 illustrates an example process 400 for implementing the techniques discussed herein in accordance with one or more embodiments. The example process 400 is performed, for example, by a computing device 102 of FIG. 1 or FIG. 2.

At 402, a determination is made as to whether an IMS call is about to be launched. If an IMS call is not about to be launched, the process 400 waits at 402 until an IMS call is about to be launched.

At 404, wireless networks available to the computing device are ranked based on their security levels. A wireless network having a higher security level is ranked higher than a wireless network having a lower security level. Correspondingly, a wireless network having a lower security level is ranked lower than a wireless network having a higher security level.

At 406, a top available wireless network is select. A top available wireless network refers to, for example the wireless network having a highest security level for communication (e.g., for an IMS call), or a wireless network having a security level that satisfies security criteria for the IMS call. Other factors may also be taken into account in determining the top available wireless network, such as the signal strengths of the available wireless networks, the data transfer speeds of the available wireless networks, and so forth.

At 408, the computing device connects to the top available wireless network if the top available wireless network is different than the original wireless network (the wireless network the computing device was connected to when the determination at 402 that an IMS call is about to be launched was made). This connecting can include, for example, performing packet data network (PDN) registration with the top available wireless network. At 408, the computing device can also disconnect from the wireless network it was previously connected to (the original wireless network).

At 410, the IMS call proceeds. When the IMS call is completed, the computing device can optionally disconnect from the top available wireless network selected at 406 and re-connect to the original wireless network.

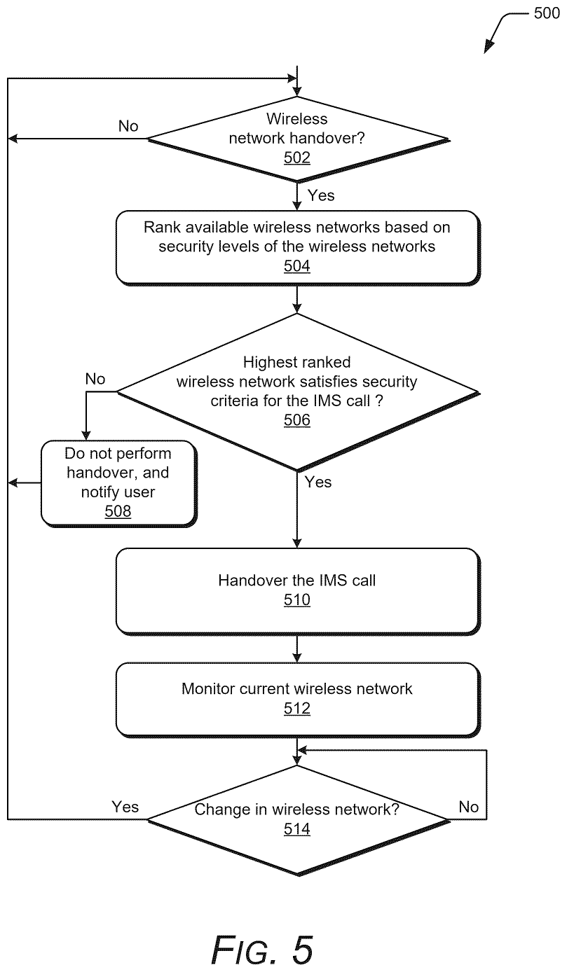

FIG. 5 illustrates an example process 500 for implementing the techniques discussed herein in accordance with one or more embodiments. The example process 500 is performed, for example, by a computing device 102 of FIG. 1 or FIG. 2.

At 502, a determination is made as to whether a wireless network handover is to be performed. A wireless network handover refers to the computing device 102 being handed over from one wireless network to another wireless network, e.g., the computing device 102 changes from being connected to a current wireless network to being connected to a different wireless network. Such a handover can occur in various situations, such as in cases where the signal strength of the current wireless network falls below a threshold strength, causing the computing device 102 to be handed over to another wireless network having a strong signal strength. If a wireless network handover is not to be performed, the process 500 waits at 502 until a wireless network handover is to be performed.

At 504, wireless networks available to the computing device are ranked based on their security levels. A wireless network having a higher security level is ranked higher than a wireless network having a lower security level. Correspondingly, a wireless network having a lower security level is ranked lower than a wireless network having a higher security level.

At 506, a check is made as to whether the highest ranked wireless network satisfies security criteria for the IMS call.

At 508, if the highest ranked wireless network does not satisfy the security criteria for the IMS call, the handover is not performed, and the user is notified. The process 500 returns to 502. It should be noted that this may result in situations where the IMS call is dropped or lost due to a low signal strength of the current wireless network, but prevents the IMS call from being handed over to a wireless network that does not have a high enough security level. Additionally, or alternatively, a user input can be received indicating that the IMS call is to be allowed to continue despite the security criteria not being satisfied.

At 510, the IMS call is handed over to another wireless network, such as a top available wireless network. As discussed above, a top available wireless network refers to, for example the wireless network having a highest security level for communication, or a wireless network having a security level that satisfies security criteria for the IMS call. Other factors may also be taken into account in determining the top available wireless network, such as the signal strengths of the available wireless networks, the data transfer speeds of the available wireless networks, and so forth.

At 512, the current wireless network, which is the wireless network the IMS call was handed over to in 510, is monitored. This monitoring refers to monitoring the characteristics of or performance of the current wireless network, such as the signal strength of the wireless network, the data transfer speed of the wireless network, and so forth.

At 514, the process 500 waits at 514 if there is no change in the wireless network (e.g., no change in the characteristics or performance of the current wireless network). If there is a change in the wireless network, the process returns to 502.

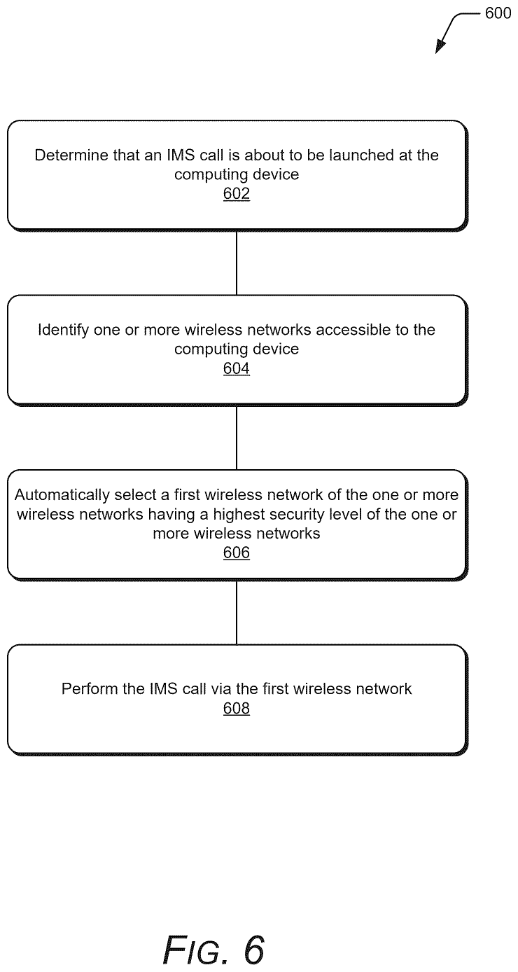

FIG. 6 illustrates an example process 600 for implementing the techniques discussed herein in accordance with one or more embodiments. The process 600 is carried out by a computing device, such as a computing device 102 of FIGS. 1-3, and can be implemented in software, firmware, hardware, or combinations thereof. Process 600 is shown as a set of acts and is not limited to the order shown for performing the operations of the various acts.

At 602, a determination is made that an IMS call is about to be launched at the computing device. This determination can be made, for example, by receiving, via a wireless network that the computing device 102 is currently connected to, an indication that there is an incoming IMS call to be communicated to the computing device, or by determining that a particular application (e.g., a communication application) has been opened, launched, or become a foreground application on the computing device.

At 604, one or more wireless networks accessible to the computing device are identified. These wireless networks can include at least one WLAN and at least one WWAN.

At 606, a first wireless network of the one or more wireless networks having a highest security level of the one or more wireless networks is automatically selected. This can be, for example, one of the one or more wireless networks having a highest security level and a highest signal strength and/or highest data transfer rate.

At 608, the IMS call is performed via the first wireless network.

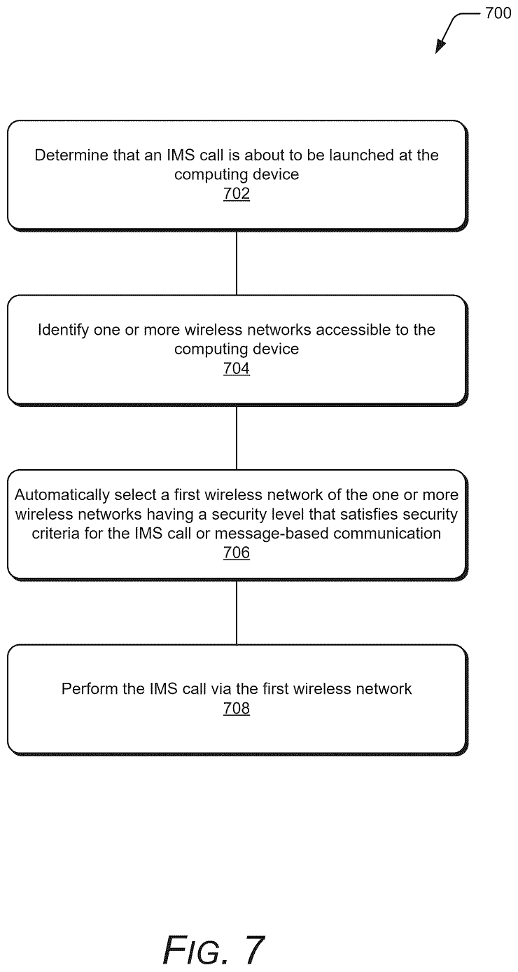

FIG. 7 illustrates an example process 700 for implementing the techniques discussed herein in accordance with one or more embodiments. The process 700 is carried out by a computing device, such as a computing device 102 of FIGS. 1-3, and can be implemented in software, firmware, hardware, or combinations thereof. Process 700 is shown as a set of acts and is not limited to the order shown for performing the operations of the various acts.

At 702, a determination is made that IMS call is about to be launched at the computing device. This determination can be made, for example, by receiving, via a wireless network that the computing device 102 is currently connected to, an indication that there is an incoming IMS call to be communicated to the computing device a receiving, or by determining that a particular application (e.g., a communication application) has been opened, launched, or become a foreground application on the computing device.

At 704, one or more wireless networks accessible to the computing device are identified. These wireless networks can include at least one WLAN and at least one WWAN.

At 706, a first wireless network of the one or more wireless networks having a security level that satisfies security criteria for the IMS call is automatically selected. This can be, for example, one of the one or more wireless networks that satisfies the security criteria and has the strongest signal and/or highest data transfer rate.

At 708, the IMS call is performed via the first wireless network.

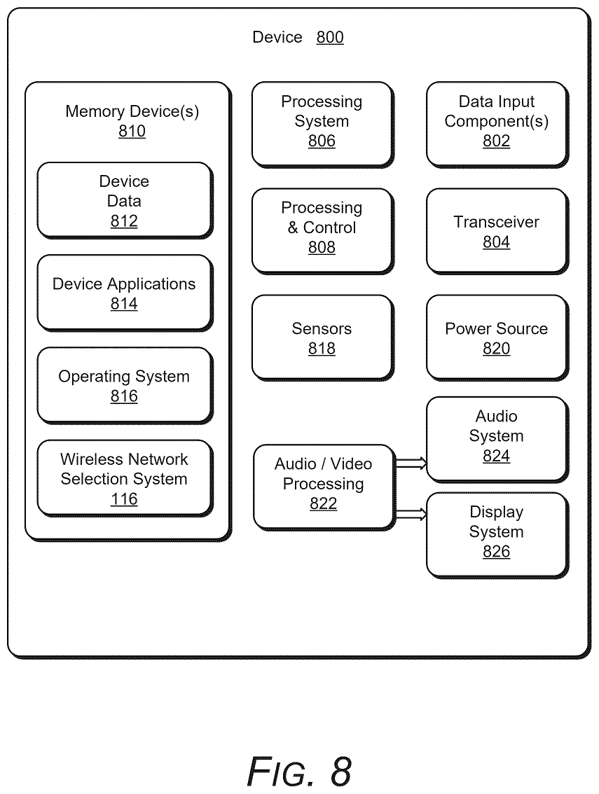

FIG. 8 illustrates various components of an example electronic device that can implement embodiments of the techniques discussed herein. The electronic device 800 can be implemented as any of the devices described with reference to the previous FIG.s, such as any type of client device, mobile phone, tablet, computing, communication, entertainment, gaming, media playback, or other type of electronic device or computing device. In one or more embodiments the electronic device 800 includes the wireless network selection system 116, described above.

The electronic device 800 includes one or more data input components 802 via which any type of data, media content, or inputs can be received such as user-selectable inputs, messages, music, television content, recorded video content, and any other type of text, audio, video, or image data received from any content or data source. The data input components 802 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 802 may also include various other input components such as microphones, touch sensors, touchscreens, keyboards, and so forth.

The device 800 includes communication transceivers 804 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as long term evolution (LTE) networks, or fifth generation networks).

The device 800 includes a processing system 806 of one or more processors (e.g., any of microprocessors, controllers, and the like) or a processor and memory system implemented as a system-on-chip (SoC) that processes computer-executable instructions. The processing system 806 may be implemented at least partially in hardware, which can include components of an integrated circuit or on-chip system, an ASIC, aN FPGA, a CPLD, and other implementations in silicon or other hardware.

Additionally, or alternatively, the device can be implemented with any one or combination of software, hardware, firmware, or fixed logic circuitry that is implemented in connection with processing and control circuits, which are generally identified at 808. The device 800 may further include any type of a system bus or other data and command transfer system that couples the various components within the device. A system bus can include any one or combination of different bus structures and architectures, as well as control and data lines.

The device 800 also includes computer-readable storage memory devices 810 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 810 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory device 810 provides data storage mechanisms to store the device data 812, other types of information or data, and various device applications 814 (e.g., software applications). For example, an operating system 816 can be maintained as software instructions with a memory device and executed by the processing system 806 to cause the processing system 806 to perform various acts. The device applications 814 may also include a device manager, such as any form of a control application, software application, signal-processing and control module, code that is native to a particular device, a hardware abstraction layer for a particular device, and so on.

The device 800 can also include one or more device sensors 818, such as any one or more of an ambient light sensor, a proximity sensor, a touch sensor, an infrared (IR) sensor, accelerometer, gyroscope, thermal sensor, audio sensor (e.g., microphone), and the like. The device 800 can also include one or more power sources 820, such as when the device 800 is implemented as a mobile device. The power sources 820 may include a charging or power system, and can be implemented as a flexible strip battery, a rechargeable battery, a charged super-capacitor, or any other type of active or passive power source.

The device 800 additionally includes an audio or video processing system 822 that generates one or both of audio data for an audio system 824 and display data for a display system 826. In accordance with some embodiments, the audio/video processing system 822 is configured to receive call audio data from the transceiver 804 and communicate the call audio data to the audio system 824 for playback at the device 800. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Additionally, or alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for secure IMS calls have been described in language specific to features or methods, the subject of the appended claims is not necessarily limited to the specific features or methods described. Rather, the specific features and methods are disclosed as example implementations of techniques for implementing secure IMS calls. Further, various different embodiments are described, and it is to be appreciated that each described embodiment can be implemented independently or in connection with one or more other described embodiments. Additional aspects of the techniques, features, and/or methods discussed herein relate to one or more of the following.

In some aspects, the techniques described herein relate to a computing device including: at least one memory; and at least one processor coupled with the at least one memory and configured to cause the computing device to: determine that an IMS call is about to be launched at the computing device; identify one or more wireless networks accessible to the computing device; automatically select a first wireless network of the one or more wireless networks having a highest security level of the one or more wireless networks; and perform the IMS call via the first wireless network.

In some aspects, the techniques described herein relate to a computing device, wherein the IMS call comprises a voice call, a video telephony call, a real-time text call, or a rich communication services message.

In some aspects, the techniques described herein relate to a computing device, wherein the one or more wireless networks have different security levels.

In some aspects, the techniques described herein relate to a computing device, wherein the at least one processor is further configured to cause the computing device to: automatically connect to the first wireless network to perform the IMS call; and automatically connect, based at least in part on the IMS call having been completed, to a second wireless network, wherein the computing device was connected to the second wireless network prior to performing the IMS call.

In some aspects, the techniques described herein relate to a computing device, wherein the at least one processor is further configured to cause the computing device to: automatically select, during the IMS call, a second network of the one or more wireless networks having a security level that satisfies security criteria for the IMS call; and handover the IMS call to the second network.

In some aspects, the techniques described herein relate to a computing device, wherein the at least one processor is further configured to cause the computing device to automatically select the second network based at least in part on a received signal strength of the first wireless network.

In some aspects, the techniques described herein relate to a computing device, wherein the one or more wireless networks include at least one wireless local area network (WLAN) and at least one wireless wide area network (WWAN).

In some aspects, the techniques described herein relate to a computing device including: at least one memory; and at least one processor coupled with the at least one memory and configured to cause the computing device to: determine that an IMS call is about to be launched at the computing device; identify one or more wireless networks accessible to the computing device; automatically select a first wireless network of the one or more wireless networks having a security level that satisfies security criteria for the IMS call; and perform the IMS call via the first wireless network.

In some aspects, the techniques described herein relate to a computing device, wherein the IMS call comprises a voice call, a video telephony call, a real-time text call, or a rich communication services message.

In some aspects, the techniques described herein relate to a computing device, wherein the at least one processor is further configured to cause the computing device to determine the security criteria for the IMS call, and wherein the security criteria is different for different types of IMS calls.

In some aspects, the techniques described herein relate to a computing device, wherein the one or more wireless networks have different security levels.

In some aspects, the techniques described herein relate to a computing device, wherein the at least one processor is further configured to cause the computing device to: automatically connect to the first wireless network to perform the IMS call; and automatically connect, based at least in part on the IMS call having been completed, to a second wireless network, wherein the computing device was connected to the second wireless network prior to performing the IMS call.

In some aspects, the techniques described herein relate to a computing device, wherein the at least one processor is further configured to cause the computing device to: automatically select, during the IMS call, a second network of the one or more wireless networks having a security level that satisfies security criteria for the IMS call; and handover the IMS call to the second network.

In some aspects, the techniques described herein relate to a computing device, wherein the at least one processor is further configured to cause the computing device to automatically select the second network based at least in part on a received signal strength of the first wireless network.

In some aspects, the techniques described herein relate to a computing device, wherein the one or more wireless networks include at least one wireless local area network (WLAN) and at least one wireless wide area network (WWAN).

In some aspects, the techniques described herein relate to a method including: determining that an IMS call is about to be launched at a computing device; identifying one or more wireless networks accessible to the computing device; automatically selecting a first wireless network of the one or more wireless networks having a highest security level of the one or more wireless networks; and performing the IMS call via the first wireless network.

In some aspects, the techniques described herein relate to a method, wherein the one or more wireless networks have different security levels.

In some aspects, the techniques described herein relate to a method, further including: automatically connecting to the first wireless network to perform the IMS call; and automatically connecting, based at least in part on the IMS call having been completed, to a second wireless network, wherein the computing device was connected to the second wireless network prior to performing the IMS call.

In some aspects, the techniques described herein relate to a method, further including: automatically selecting, during the IMS call, a second network of the one or more wireless networks having a security level that satisfies security criteria for the IMS call; and handing over the IMS call to the second network.

In some aspects, the techniques described herein relate to a method, wherein the one or more wireless networks include at least one wireless local area network (WLAN) and at least one wireless wide area network (WWAN).

What is claimed is:

1. A computing device comprising:
at least one memory; and
at least one processor coupled with the at least one memory and configured to cause the computing device to:
determine that an IP Multimedia Subsystem (IMS) call is about to be launched at the computing device;
identify one or more wireless networks accessible to the computing device;
automatically select a first wireless network of the one or more wireless networks having a highest security level of the one or more wireless networks; and
perform the IMS call via the first wireless network.

2. The computing device of claim 1, wherein the at least one processor is further configured to cause the computing device to:
determine, for each of the one or more networks, a security level for the network based at least in part on a level of international mobile subscriber identity (IMSI) encryption strength, a password encryption strength, a generation of the wireless network, or a combination thereof.

3. The computing device of claim 1, wherein the one or more wireless networks have different security levels.

4. The computing device of claim 1, wherein the at least one processor is further configured to cause the computing device to:
automatically connect to the first wireless network to perform the IMS call; and
automatically connect, based at least in part on the IMS call having been completed, to a second wireless network, wherein the computing device was connected to the second wireless network prior to performing the IMS call.

5. The computing device of claim 1, wherein the at least one processor is further configured to cause the computing device to:
automatically select, during the IMS call, a second network of the one or more wireless networks having a security level that satisfies security criteria for the IMS call; and
handover the IMS call to the second network.

6. The computing device of claim 5, wherein the at least one processor is further configured to cause the computing device to automatically select the second network based at least in part on a received signal strength of the first wireless network.

7. The computing device of claim 1, wherein the one or more wireless networks include at least one wireless local area network (WLAN) and at least one wireless wide area network (WWAN).

8. A computing device comprising:
at least one memory; and
at least one processor coupled with the at least one memory and configured to cause the computing device to:
determine that an IP Multimedia Subsystem (IMS) call is about to be launched at the computing device;
identify one or more wireless networks accessible to the computing device;
automatically select a first wireless network of the one or more wireless networks having a security level that satisfies security criteria for the IMS call; and
perform the IMS call via the first wireless network.

9. The computing device of claim 8, wherein the IMS call comprises a voice call, a video telephony call, a real-time text call, or a rich communication services message.

10. The computing device of claim 8, wherein the at least one processor is further configured to cause the computing device to determine the security criteria for the IMS call, and wherein the security criteria is different for different types of IMS calls.

11. The computing device of claim 8, wherein the one or more wireless networks have different security levels.

12. The computing device of claim 8, wherein the at least one processor is further configured to cause the computing device to:
automatically connect to the first wireless network to perform the IMS call; and
automatically connect, based at least in part on the IMS call having been completed, to a second wireless network, wherein the computing device was connected to the second wireless network prior to performing the IMS call.

13. The computing device of claim 8, wherein the at least one processor is further configured to cause the computing device to:
automatically select, during the IMS call, a second network of the one or more wireless networks having a security level that satisfies security criteria for the IMS call; and
handover the IMS call to the second network.

14. The computing device of claim 13, wherein the at least one processor is further configured to cause the computing device to automatically select the second network based at least in part on a received signal strength of the first wireless network.

15. The computing device of claim 8, wherein the one or more wireless networks include at least one wireless local area network (WLAN) and at least one wireless wide area network (WWAN).

16. A method comprising:
determining that an IP Multimedia Subsystem (IMS) call is about to be launched at a computing device;
identifying one or more wireless networks accessible to the computing device;
automatically selecting a first wireless network of the one or more wireless networks having a highest security level of the one or more wireless networks; and
performing the IMS call via the first wireless network.

17. The method of claim 16, wherein the one or more wireless networks have different security levels.

18. The method of claim 16, further comprising:
automatically connecting to the first wireless network to perform the IMS call; and
automatically connecting, based at least in part on the IMS call having been completed, to a second wireless network, wherein the computing device was connected to the second wireless network prior to performing the IMS call.

19. The method of claim 16, further comprising:
automatically selecting, during the IMS call, a second network of the one or more wireless networks having a security level that satisfies security criteria for the IMS call; and
handing over the IMS call to the second network.

20. The method of claim 16, wherein the one or more wireless networks include at least one wireless local area network (WLAN) and at least one wireless wide area network (WWAN).
